(19) United States
(12) Patent Application Publication
(10) Pub. No.: US 2003/0047224 A1
(43) Pub. Date: Mar. 13, 2003

(54) Apparatus and method to improve the flow of viscous liquids

(76) Inventors: Bernard Cohen, Berkeley Lake, GA (US); Lamar Heath Gipson, Acworth, GA (US); Lee Kirby Jameson, Roswell, GA (US)

Correspondence Address: Scott B. Garrison, Kimberly-Clark, Worldwide, Inc., Patent Department, 401 North Lake Street, Neenah, WI, 54956, US

(21) Appl. No.: 09/948,184

(22) Filed: Sep. 7, 2001

(51) Int. Cl. G05D 7/00

(52) U.S. Cl. 137/828

(57) ABSTRACT

An ultrasonic apparatus and a method for improving the transfer, delivery, and flow of viscous liquids including heavy fuel and lubricating oils, such as bunker, molten metals, molten bitumens, food products, and other heavy viscous liquids. The apparatus includes a housing and a means for applying ultrasonic energy to a portion of the pressurized liquid as the liquid passes through the housing. The housing includes a chamber adapted to receive viscous liquid under pressure, a second smaller chamber or vestibular cavity in communication with the chamber, an inlet adapted to supply the chamber with the pressurized liquid, and an exit orifice adapted to pass the liquid out of the housing. When the means for applying ultrasonic energy is excited, it applies ultrasonic energy to the pressurized liquid contained within the vestibular cavity without mechanically vibrating the tip.

### BACKGROUND OF THE INVENTION

The present invention relates to an apparatus and method for improving the flow of viscous liquids including heavy fuels, lubricating oils, molten metals, molten bitumens, food products and other viscous liquids by the application of ultrasonic energy to the transfer and delivery of such liquids.

### SUMMARY OF THE INVENTION

The present invention provides an ultrasonic apparatus and a method for improving the transfer and delivery of viscous liquids including heavy fuel and lubricating oils, such as bunker, other heavy viscous oils, and lubricating oils; molten metals, molten bitumens, food products, and other viscous liquids. This is accomplished by the application of ultrasonic energy to the liquid during the transfer and/or delivery of the liquid through the system.

The apparatus includes a housing and a means for applying ultrasonic energy to a portion of the liquid as it passes through the housing. The housing includes a chamber adapted to receive a viscous liquid under pressure, a second smaller chamber or vestibular cavity in communication with the chamber, an inlet adapted to supply the chamber with the pressurized liquid, and an exit orifice (or a plurality of exit orifices) adapted to pass the liquic out of the housing. The vestibular cavity may be machined into the walls of the housing or alternatively the housing may comprise one or more sections that when attached one to the other contain the inlet, exit orifice or orifices, chamber, and vestibular cavity.

The vestibular cavity receives liquid directly from the chamber and passes it to the exit orifice. The liquid contained within the vestibular cavity is subjected to vibrational energy supplied by the means for applying ultrasonic energy. As such, the means for applying ultrasonic energy may be located within the chamber but terminates in close proximity to the vestibular cavity without actually being wholly or partially contained within the vestibular cavity itself. To ensure that the greatest quantity of vibrational energy is transferred into the liquid, the means for applying ultrasonic energy may comprise a vibrational tip or surface having an area equal which is equal to the area defined by the entrance of the vestibular cavity. Moreover, this vibrational tip or surface may be both coaxially aligned with and in parallel spaces relation to the entrance of the vestibular cavity.

The means for applying ultrasonic energy may comprise, for example, an immersed ultrasonic horn. According to the invention, the means for applying ultrasonic energy is affixed to the housing in such a manner that no significant vibrational energy is transferred into the housing itself. However, the means for applying ultrasonic energy may extend into the housing and terminate within the chamber itself proximal to the entrance of the vestibular chamber as stated above.

In one embodiment of the apparatus, the housing may have a first end and a second end and the exit orifice is adapted to receive the pressurized viscous liquid from the chamber and pass the pressurized viscous liquid along a first axis. The means for applying ultrasonic energy to a portion of the pressurized viscous liquid is an ultrasonic horn having a first end and a second end. The horn is adapted, upon excitation by ultrasonic energy, to have a node and a longitudinal mechanical excitation axis. The horn is located in the second end of the housing in a manner such that the first end of the horn is located outside of the housing and the second end terminates in a tip or surface which is located inside the housing within the chamber and terminating in close proximity to the vestibular cavity and further being substantially aligned along the longitudinal mechanical excitation axis with a central axis of the entrance to the vestibular cavity. The horn is desirably affixed to the housing at the node of the horn. Alternatively, both the first end and the second end of the horn may be located inside the housing so long as the horn is affixed at its node thus eliminating the transfer of any significant vibrational energy to the housing or exit orifice.

The longitudinal excitation axis of the ultrasonic horn desirably will be substantially parallel with the first axis. Furthermore, the second end of the horn desirably will have a cross-sectional area approximately the same as or greater than a minimum area which encompasses the area defining the entrance to the vestibular cavity in the housing. This configuration focuses the vibrational energy into the liquid contained within the vestibular cavity.

The apparatus may have an ultrasonic horn having a vibrator means coupled to the first end of the horn. The vibrator means may be a piezoelectric transducer or a magnetostrictive transducer. The transducer may be coupled directly to the horn or by means of an elongated waveguide. The elongated waveguide may have any desired input:output mechanical excitation ratio, although ratios of 1:1 and 1:1.5 are typical for many applications. The ultrasonic energy typically will have a frequency of from about 15 kHz to about 500 kHz, although other frequencies are contemplated.

In an embodiment of the present invention, the ultrasonic horn may be composed partially or entirely of a magnetostrictive material. The horn may be surrounded by a coil (which may be immersed in the viscous liquid) capable of inducing a signal into the magnetostrictive material causing it to vibrate at ultrasonic frequencies. In such cases, the ultrasonic horn may simultaneously be the transducer and the means for applying ultrasonic energy to the viscous liquid.

The apparatus includes a housing and a means for applying ultrasonic energy to a portion of the pressurized viscous liquid passing through the housing. The housing includes a chamber adapted to receive the pressurized viscous liquid, an inlet adapted to supply the chamber with the pressurized viscous liquid from an external source, a second smaller chamber or vestibular cavity in communication with the chamber, an exit orifice (or a plurality of exit orifices), the exit orifice serving to pass the liquid out of the housing at a higher flow rate without increasing pressure or temperature of the liquid.

As such, disposed between the chamber and the exit orifice or orifices is the vestibular cavity. The vestibular cavity serves as a reservoir for the viscous liquid received from the chamber. The vestibular cavity also serves as the focal point to which the vibrational energy is directed. From the vestibular chamber, the liquid now excited by the application of ultrasonic energy is passed to the exit orifice.

Generally speaking, the means for applying ultrasonic energy is located within the chamber. For example, the means for applying ultrasonic energy may be an immersed ultrasonic horn. According to the invention, the means for applying ultrasonic energy is located within the chamber in a manner such that no mechanical vibrational energy is applied to the tip (i.e., the walls of the tip defining the exit orifice), one such manner is to affix the means to the housing at a nodal point.

In one embodiment of the present invention, the housing may have a first end and a second end. Contained within one end of the housing is an exit orifice adapted to receive the pressurized viscous liquid from the vestibular cavity and pass the pressurized liquid along a first axis. The means for applying ultrasonic or vibrational energy to a portion of the pressurized viscous liquid is an ultrasonic horn having a first end and a second end. The horn is adapted, upon excitation by ultrasonic energy, to have a node and a longitudinal mechanical excitation axis. The horn is located in the second end of the housing and is fastened at its node in a manner such that the first end of the horn is located outside of the housing and the second end is located inside the housing, within the chamber, and is in close proximity but does not cross an imaginary plane defined by the entrance to the vestibular cavity.

The longitudinal excitation axis of the ultrasonic horn desirably will be substantially parallel with the first axis. Furthermore, the second end of the horn desirably will be substantially aligned along the longitudinal mechanical excitation axis with a central axis of the vestibular cavity and will have a cross-sectional area the same as the area defining the entrance to the vestibular cavity in the housing. Upon excitation by ultrasonic energy, the ultrasonic horn is adapted to apply ultrasonic energy to the pressurized viscous liquid within the vestibular cavity but not to transfer vibrational energy to the walls of the housing itself or to the exit orifice. A small amount of energy may be lost to the viscous liquid contained within the chamber itself but a very significant majority of the energy is directed into the reservoir of viscous liquid contained within the vestibular cavity and does not affect the exit orifice itself. One manner of maximizing the energy transferred from the horn into the liquid contained within the vestibular cavity is to minimize or desirably eliminate any surface of the horn perpendicular to the vibrational motion of the horn itself, with the exception of the tip of the horn itself which serves as the focal point of the vibrational energy. By axially aligning the tip of the horn in parallel spaced relation to the entrance to the vestibular cavity, the vibrational energy can be focused into the liquid contained within the vestibular cavity itself.

The present invention contemplates the use of an ultrasonic horn having a vibrator means coupled to the first end of the horn. The vibrator means may be a piezoelectric transducer or a magnetostrictive transducer. The transducer may be coupled directly to the horn or by means of an elongated waveguide. The elongated waveguide may have any desired input:output mechanical excitation ratio, although ratios of 1:1 and 1:1.5 are typical for many applications. The ultrasonic energy typically will have a frequency of from about 15 kHz to about 500 kHz, although other frequencies are contemplated.

In an embodiment of the present invention, the ultrasonic horn may be partially or completely composed of a magnetostrictive material and be surrounded by a coil (which may be immersed in the liquid) capable of inducing a signal into the magnetostrictive material causing it to vibrate at ultrasonic frequencies. In such case, the ultrasonic horn may be simultaneously the transducer and the means for applying ultrasonic energy to a viscous liquid.

In an aspect of the present invention, the exit orifice may have a diameter of less than about 0.1 inch (2.54 mm). For example, the exit orifice may have a diameter of from about 0.0001 to about 0.1 inch (0.00254 to 2.54 mm) As a further example, the exit orifice may have a diameter of from about 0.001 to about 0.01 inch (0.0254 to 0.254 mm). The vestibular cavity may have a diameter of about 0.125 inch (about 3.2 mm) terminating in a convergent passageway which in turn leads to the exit orifice. The passageway may have frustoconical walls with about a 30 degree convergence as measured from a central axis coinciding with the first axis.

According to the invention, the exit orifice may be a single exit orifice or a plurality of exit orifices. The exit orifice may be an exit capillary. The exit capillary may have a length to diameter ratio (L/D ratio) of ranging from about 4:1 to about 10:1. Of course, the exit capillary may have a L/D ratio of less than 4:1 or greater than 10:1.

The apparatus and method may be used in fuel and lubricating oil transfer and supply systems. It may also be used in pumping or tranferring molten metals, molten bitumens, food products, and other viscous liquids. The apparatus has the ability to increase the flow rates of viscous liquids without increasing the pressure or temperature of the liquid supply. The apparatus and method of the present invention may also be used to emulsify multi-component liquids as well as enable additives and contaminants to remain emulsified in such liquids.

### BRIEF DESCRIPTION OF THE DRAWINGS

FIG. 1 is a diagrammatic cross-sectional representation of one embodiment of the apparatus of the present invention.

FIG. 2 is an enlarged view of an end of the diagrammatic cross-sectional representation of FIG. 1.

FIG. 3 is a diagrammatic cross-sectional representation of another embodiment of the apparatus of the present invention.

### DETAILED DESCRIPTION OF THE INVENTION

As used herein, the term “liquid” refers to an amorphous (noncrystalline) form of matter intermediate between gases and solids, in which the molecules are much more highly concentrated than in gases, but much less concentrated than in solids. A liquid may have a single component or may be made of multiple components. The components may be other liquids, solids and/or gases. For example, a characteristic of liquids is their ability to flow as a result of an applied force. Liquids that flow immediately upon application of force and for which the rate of flow is directly proportional to the force applied are generally referred to as Newtonian liquids. Some liquids have abnormal flow response when force is applied and exhibit non-Newtonian flow properties.

As used herein, the term “node” means the point on the longitudinal excitation axis of the ultrasonic horn at which no longitudinal motion of the horn occurs upon excitation by ultrasonic energy. The node sometimes is referred in the art, as well as in this specification, as the nodal point or nodal plane.

The term “close proximity” is used herein in a qualitative sense only. That is, the term is used to mean that the means for applying ultrasonic energy is sufficiently close to the entrance of the vestibular cavity to apply the ultrasonic energy primarily to the reservoir of liquid contained within the vestibular cavity. The term is not used in the sense of defining specific distances from the vestibular cavity.

As used herein, the term “viscous liquid” means a liquid having a viscosity between about 500 cP to about 5000 cP.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, solvents, particulates and materials added to enhance processability of the composition.

Generally speaking, the apparatus of the present invention includes a housing and a means for applying ultrasonic energy to a portion of a pressurized viscous liquid. The housing in part defines a chamber adapted to receive the pressurized liquid, a second smaller chamber or vestibular cavity in communication with the chamber, an inlet (e.g., inlet orifice) adapted to supply the chamber with the pressurized liquid, and an exit orifice (e.g., extrusion orifice) adapted to receive the pressurized liquid from the vestibular cavity and pass the liquid out of the housing. The means for applying ultrasonic energy is at least partially located within the chamber. For example, the means for applying ultrasonic energy can be located partially within the chamber or the means for applying ultrasonic energy can be located entirely within the chamber.

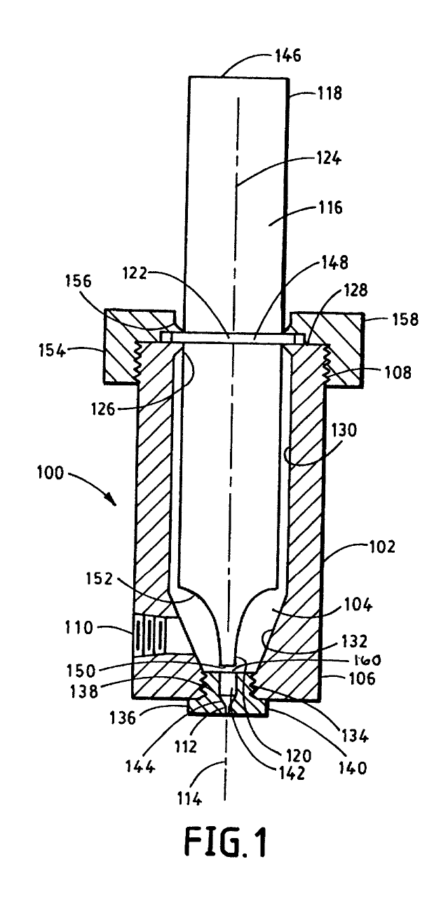

Referring now to FIG. 1, there is shown, not necessarily to scale, an exemplary apparatus for imparting vibrational energy to a viscous liquid enabling it to flow more easily without increasing the pressure or temperature of the liquid. The apparatus 100 includes a housing 102 which partially defines a chamber 104 having a first volume adapted to receive a pressurized viscous liquid. The housing 102 has a first end 106 and a second end 108. The housing 102 also has an inlet 110 (e.g., inlet orifice) connected to the chamber 104 adapted to supply the chamber 104 with the pressurized viscous liquid.

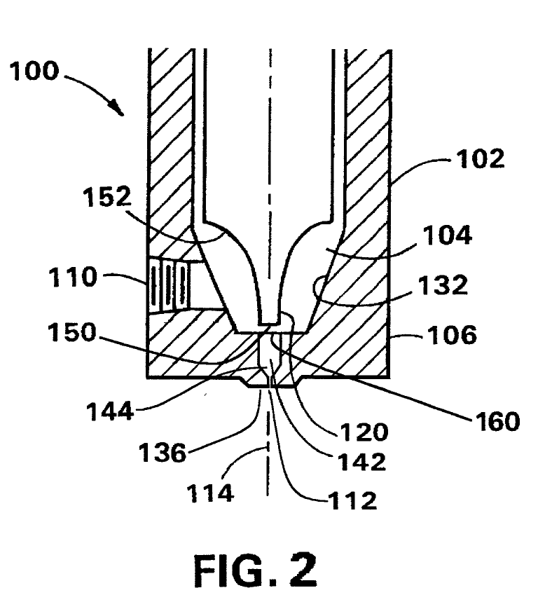

The first end 106 of the housing 102 may terminate in a tip 136. The tip 136 may be formed in the first end 106 as shown in FIG. 2 or alternatively may comprise a separate, interchangeable component as depicted in FIG. 1. An exit orifice 112 (which may also be referred to as an extrusion orifice) is located in the tip 136; it is adapted to receive the pressurized viscous liquid from the chamber 104 and ultimately pass the liquid out of the housing 102 along a first axis 114.

Referring to FIG. 1 and to FIG. 2 for greater detail, a vestibular cavity 142 is also located in the tip 136 and is disposed between the chamber 104 and the exit orifice 112.

The vestibular cavity 142 may be machined into the walls of the housing 102 or alternatively the housing 102 may comprise one or more sections that when attached one to the other contain the inlet 110, exit orifice 112 or orifices, chamber 104, and vestibular cavity 142. The vestibular cavity may be directly connected to the exit orifice 112 or alternatively the two may be interconnected via a passageway 144. The vestibular cavity 142 defines a second volume which is smaller than the first volume of the chamber 104. The path between the chamber 104 and the vestibular cavity 142 is formed by a transitional region or entrance 160 having a cross-sectional area formed in the side walls of the apparatus which leads from the chamber 104 to the vestibular cavity 142.

The means for applying ultrasonic energy may comprise an ultrasonic horn 116 located in the second end 108 of the housing 102. The ultrasonic horn has a first end 118 and a second end 120. The horn 116 is adapted, upon excitation by ultrasonic energy, to have a nodal point or nodal plane 122 and a longitudinal mechanical excitation axis 124. The horn 116 is rigidly coupled to the housing 102 at this nodal point 122 so that the only portion of the horn 116 to contact the housing 102 is that portion lying on the nodal plane 122. Desirably, the first axis 114 and the mechanical excitation axis 124 are substantially parallel. More desirably, the first axis 114 and the mechanical excitation axis 124 substantially coincide, as shown in FIG. 1. Most desirably, the first axis 114 and the mechanical excitation axis 124 actually coincide.

The horn 116 is located in the second end 108 of the housing 102 in a manner such that the first end 118 of the horn 116 is located outside of the housing 102 and the second end 120 of the horn 116 is located inside the housing 102 within the chamber 104. The second end 120 of the horn 116 terminates in a surface or tip 150 that is positioned in close proximity to the vestibular cavity 142. Furthermore this tip 150 is substantially normal to and substantially coaxially aligned along the longitudinal mechanical excitation axis of the horn 116 with a central axis of the vestibular cavity 142. In some embodiments, the cross-sectional area of the tip 150 of the horn 116 is substantially equal to the cross-sectional area of the entrance 160.

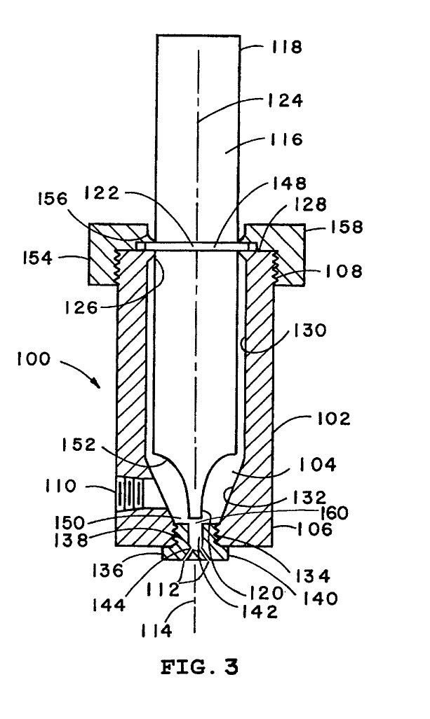

The size and shape of the apparatus of the present invention can vary widely, depending, at least in part, on the number and arrangement of exit orifices (e.g., extrusion orifices) and the operating frequency of the means for applying ultrasonic energy. For example, the housing 102 may be cylindrical, rectangular, or any other shape. Moreover, the housing 102 may have a single exit orifice 112 or a plurality of exit orifices 112. A plurality of exit orifices may be arranged in a pattern, including but not limited to, a linear or a circular pattern. Each of the exit orifices may be associated with a dedicated vestibular cavity. Likewise, a plurality of exit orifices might be associated with a single vestibular cavity or cavities as shown in FIG. 3. Furthermore, the cross-sectional profile of the exit orifice 112 and the orientation of the exit orifice with respect to the longitudinal mechanical excitation axis does not result in a negative impact on the use of the apparatus as a viscous liquid pump or flow control valve.

The means for applying ultrasonic energy is located within the chamber, typically at least partially surrounded by the pressurized viscous liquid, i.e., the chamber 104 includes both at least a portion of the means for applying ultrasonic energy as well as the viscous liquid to be acted upon. Such means is adapted to apply the ultrasonic energy to the pressurized viscous liquid contained within the vestibular cavity as it is passed to the exit orifice. Stated differently, such means is adapted to apply ultrasonic energy primarily to a portion of the pressurized liquid contained within the vestibular cavity 142 and each exit orifice 112. Such means may be located completely or partially within the chamber 104, desirably within close proximity to the entrance 160 of the vestibular cavity 142.

When the means for applying ultrasonic energy is an ultrasonic horn 116, the horn 116 conveniently extends through the housing 102, such as through the second end 108 of the housing 102 and extends toward the first end 106 of the housing 102 as identified in FIG. 1. However, the present invention comprehends other configurations. For example, the horn 116 may extend through a wall of the housing, rather than through an end. Moreover, neither the first axis 114 nor the longitudinal excitation axis 124 of the horn 116 need be vertical. If desired, the longitudinal mechanical excitation axis of the horn may be at an angle to the first axis. Nevertheless, the longitudinal mechanical excitation axis 124 of the ultrasonic horn 116 desirably will be substantially parallel with the first axis 114. More desirably, the longitudinal mechanical excitation axis 124 of the ultrasonic horn 116 and the first axis 114 will substantially coincide. Most desirably, the first axis 114 and the mechanical excitation axis 124 actually coincide, as shown in FIGS. 1-3.

If desired, more than one means for applying ultrasonic energy may be located within the chamber defined by the housing. Moreover, a single means may apply ultrasonic energy to the portion of the pressurized viscous liquid which is in the vicinity of one or more exit orifices or is contained within one or more vestibular cavities.

According to the present invention, the ultrasonic horn may be partially or wholly composed of a magnetostrictive material. The horn may be surrounded by a coil (which may be immersed in the viscous liquid) capable of inducing a signal into the magnetostrictive material causing it to vibrate at ultrasonic frequencies. In such cases, the ultrasonic horn can simultaneously be the transducer and the means for applying ultrasonic energy to the viscous liquid.

The application of ultrasonic energy to a plurality of exit orifices may be accomplished by a variety of methods. For example, with reference again to the use of an ultrasonic horn, the second end of the horn may have a cross-sectional area which is sufficiently large so as to apply ultrasonic energy to the portion of the pressurized liquid which is in the vicinity of all of the exit orifices in the housing. In such case, the second end of the ultrasonic horn desirably will have a cross-sectional area approximately the same size as the area defining the entrance to the vestibular cavity in the housing. Alternatively, the second end of the horn may have a plurality of protrusions, or tips, equal in number to the number of individual vestibular cavities leading to exit orifices. In this instance, the cross-sectional area of each protrusion or tip desirably will be approximately the same as the cross-sectional area comprising the entrance to each respective vestibular cavity with which any specific protrusion or tip is in close proximity.

As already noted, the term “close proximity” is used herein to mean that the means for applying ultrasonic energy is sufficiently close to the area defining the entrance 160 to the vestibular cavity 142 leading to the exit orifice 112 to apply the ultrasonic energy primarily to the pressurized viscous liquid passing from the vestibular cavity 142 into the exit orifice 112. The actual distance from the tip 150 of the means for applying ultrasonic energy from the exit orifice 112 in any given situation will depend upon a number of factors, some of which are the flow rate and/or viscosity of the pressurized viscous liquid, the cross-sectional area of the tip 150 of the means for applying the ultrasonic energy relative to the cross-sectional area of the exit orifice 112, the cross-sectional area of tip 150 of the means for applying the ultrasonic energy relative to the cross-sectional area of the entrance 160 to the vestibular portion 142, the frequency of the ultrasonic energy, the gain of the means for applying the ultrasonic energy (e.g., the magnitude of the longitudinal mechanical excitation of the means for applying ultrasonic energy), the temperature of the pressurized liquid, and the rate at which the liquid passes out of the exit orifice 112.

In general, the distance of the means for applying ultrasonic energy from where the exit orifice 112 terminates in the first end 106 of the housing 102 in any given situation may be determined readily by one having ordinary skill in the art without undue experimentation. In practice, such distance will be in the range of from about 0.002 inch (about 0.05 mm) to about 1.3 inches (about 33 mm), although greater distances can be employed. Notwithstanding, the distance between the tip 150 of the means for applying ultrasonic energy and an imaginary plane formed across the entrance 160 of the vestibular cavity can range from about 0 inches (about 0 mm) to about 0.100 inch (about 2.5 mm). It is believed that the distance between the tip 150 of the means for applying ultrasonic energy and this plane formed across the entrance 160 of the vestibular cavity 142 determines the extent to which energy is applied to liquid within the chamber versus the desirable situation of applying energy solely to the liquid contained within the vestibular chamber itself i.e., the greater the distance between the tip 150 and the plane formed across the entrance to the vestibular portion, the greater the amount of energy lost to liquid not contained within the vestibular cavity. Consequently, shorter distances generally are desired in order to minimize energy losses, degradation of the pressurized viscous liquid, and other adverse effects which may result from exposure of the liquid to the ultrasonic energy. In some embodiments, these distances range from about no protrusion into the vestibular cavity to about 0.010 inch (about 0.25 mm) separation between the tip and the plane formed across the entrance to the vestibular cavity. In one desirable embodiment, the tip and the vestibular cavity are separated by a distance of about 0.005 inch (about 0.13 mm).

One advantage of the apparatus of the present invention is that it is self-cleaning. That is, the combination of supplied pressure and forces generated by ultrasonically exciting the means for supplying ultrasonic energy to the pressurized viscous liquid (without applying ultrasonic energy directly to the orifice) can remove obstructions that appear to block the exit orifice (e.g., extrusion orifice). According to the invention, the exit orifice is adapted to be self-cleaning when the means for applying ultrasonic energy is excited with ultrasonic energy (without applying ultrasonic energy directly to the orifice) while the exit orifice receives pressurized viscous liquid from the chamber via the vestibular cavity and through the passageway, if one is present, and passes the liquid out of the housing.

Desirably, the means for applying ultrasonic energy is an immersed ultrasonic horn having a longitudinal mechanical excitation axis and in which the end of the horn 116 located in the housing 102 nearest the exit orifice is in close proximity to the entrance 160 of the vestibular cavity 142, does not intrude into the vestibular cavity and does not apply vibrational energy directly to the exit orifice.

An aspect of the present invention covers an apparatus for emulsifying a pressurized multi-component viscous liquid. Generally speaking, the emulsifying apparatus has the configuration of the apparatus described above and the exit orifice is adapted to emulsify a pressurized multi-component liquid containing a viscous liquid when the means for applying ultrasonic energy is excited with ultrasonic energy while the exit orifice receives pressurized multi-component liquid from the chamber. The pressurized multi-component liquid may then be passed out of the exit orifice in the housing. The added step may enhance emulsification.

The present invention also includes a method of emulsifying a pressurized multi-component liquid. The method includes the steps of supplying a pressurized liquid to the assembly described above; exciting means for applying ultrasonic energy (located within the assembly) with ultrasonic energy while the exit orifice receives pressurized liquid from the chamber without applying vibrational energy directly to the exit orifice; and passing the liquid out of the exit orifice so that the liquid is emulsified.

The present invention also includes an apparatus and method of transferring viscous liquids such as bunker, heavy fuel oils, lube oils, molten liquids, molten bitumens, food products, and the like. In fact, another aspect of the present apparatus is that it serves a purpose typically associated with valves. Specifically the device controls or modulates the flow rate of a liquid that passes through the apparatus. The method includes the steps of supplying a viscous liquid to the assembly described above; exciting means for applying ultrasonic energy (located within the assembly) with ultrasonic energy while the exit orifice receives vibrationally excited pressurized liquid from the vestibular cavity without applying vibrational energy directly to the exit orifice; and passing the liquid out of the exit orifice without increasing the pressure or substantially increasing the temperature.

The apparatus and method may be used in viscous liquid transfer and supply systems. The vibrations imparted by the ultrasonic energy appear to change the apparent viscosity and flow characteristics of the high viscosity liquids. Furthermore, the vibrations also appear to improve the flow rate of the liquids traveling through the apparatus. The vibrations also cause breakdown and flushing out of clogging contaminants at the exit orifice. The vibrations can also cause emulsification of the viscous liquid with other components (e.g., liquid components) or additives that may be present in the stream.

The apparatus and method of the present invention may be used to emulsify multi-component viscous liquids as well as additives and contaminants at the storage facility, at points in the transfer system or piping as well as at the point where the viscous liquids exit the apparatus. For example, water entrained in certain fuels may be emulsified so that fuel/water mixture may be used in combustors. Mixed fuels and/or fuel blends including components such as, for example, methanol, water, ethanol, diesel, liquid propane gas, bio-diesel or the like can also be emulsified within the more viscous oils. The present invention can have advantages in multi-fueled engines in that it may be used to compatibalize the flow rate characteristics (e.g., apparent viscosities) of the different fuels that may be used in the multi-fueled engine.

Alternatively and/or additionally, it may be desirable to add water to one or more viscous oils and emulsify the components immediately before combustion as a way of controlling combustion and/or reducing exhaust emissions. It may also be desirable to add a gas (e.g., air, N₂O, etc.) to one or more viscous oils and ultrasonically blend or emulsify the components immediately before combustion as a way of controlling combustion and/or reducing exhaust emissions.

The present invention is further described by the example which follows. The example, however, is not to be construed as limiting in any way either the spirit or the scope of the present invention.

### EXAMPLE

### Ultrasonic Horn Apparatus

The following is a description of an exemplary ultrasonic horn apparatus of the present invention generally as shown in FIG. 1 incorporating the more desirable features described above.

With reference to FIG. 1, the housing 102 of the apparatus was a cylinder having an outer diameter of 1.375 inches (about 34.9 mm), an inner diameter of 0.875 inch (about 22.2 mm), and a length of 3.086 inches (about 78.4 mm). The outer 0.312-inch (about 7.9-mm) portion of the second end 108 of the housing was threaded with 16-pitch threads. The inside of the second end had a beveled edge 126, or chamfer, extending from the face 128 of the second end toward the first end 106 a distance of 0.125 inch (about 3.2 mm). The chamfer reduced the inner diameter of the housing at the face of the second end to 0.75 inch (about 19.0 mm). An inlet 110 (also called an inlet orifice) was drilled in the housing, the center of which was 0.688 inch (about 17.5 mm) from the first end, and tapped. The inner wall of the housing consisted of a cylindrical portion 130 and a conical frustrum portion 132. The cylindrical portion extended from the chamfer at the second end toward the first end to within 0.992 inch (about 25.2 mm) from the face of the first end. The conical frustrum portion extended from the cylindrical portion a distance of 0.625 inch (about 15.9 mm), terminating at a threaded opening 134 in the first end. The diameter of the threaded opening was 0.375 inch (about 9.5 mm); such opening was 0.367 inch (about 9.3 mm) in length.

A tip 136 was located in the threaded opening of the first end. The tip consisted of a threaded cylinder 138 having a circular shoulder portion 140. The shoulder portion was 0.125 inch (about 3.2 mm) thick and had two parallel faces (not shown) 0.5 inch (about 12.7 mm) apart. An exit orifice 112 (also called an extrusion orifice) was drilled in the shoulder portion and extended toward the threaded portion a distance of 0.087 inch (about 2.2 mm). The diameter of the extrusion orifice was 0.0145 inch (about 0.37 mm). The extrusion orifice terminated within the tip at a vestibular cavity 142 having a diameter of 0.125 inch (about 3.2 mm) and a conical frustrum passage 144 which joined the vestibular cavity with the extrusion orifice. The wall of the conical frustrum passage was at an angle of 30□ from the vertical. The vestibular cavity extended from the extrusion orifice to the end of the threaded portion of the tip, thereby connecting the chamber defined by the housing with the extrusion orifice.

The means for applying ultrasonic energy was a cylindrical ultrasonic horn 116.

The horn was machined to resonate at a frequency of 20 kHz. The horn had a length of 5.198 inches (about 132.0 mm), which was equal to one-half of the resonating wavelength, and a diameter of 0.75 inch (about 19.0 mm). The face 146 of the first end 118 of the horn was drilled and tapped for a 3/8-inch (about 9.5-mm) stud (not shown).

The horn was machined with a collar 148 at the nodal point 122. The collar was 0.094 inch (about 2.4-mm) wide and extended outwardly from the cylindrical surface of the horn 0.062 inch (about 1.6 mm). The horn 116 was affixed to the housing 102 at the collar 148. By affixing the horn to the housing at the nodal point of the horn, the transfer of vibrational energy to the housing was eliminated or at least substantially minimized. The diameter of the horn at the collar was 0.875 inch (about 22.2 mm). The second end 120 of the horn terminated in a small cylindrical tip 150 0.125 inch (about 3.2 mm) long and 0.125 inch (about 3.2 mm) in diameter. Such tip 150 was separated from the cylindrical body of the horn by a parabolic frustrum portion 152 approximately 0.5 inch (about 13 mm) in length. That is, the curve of this frustrum portion as seen in cross-section was parabolic in shape. The face of the small cylindrical tip 150 was normal to the cylindrical wall of the horn and was located about 0.005 inch (about 0.13 mm) from an imaginary plane across the entrance to the vestibular cavity. Thus, the face of the tip of the horn, i.e., the second end of the horn 150, was located immediately above the entrance to the vestibular cavity and was the same area as the planar area across the entrance of the vestibular cavity.

The first end 108 of the housing was sealed by a threaded cap 154 which also served to hold the ultrasonic horn in place. The threads extended upwardly toward the top of the cap a distance of 0.312 inch (about 7.9 mm). The outside diameter of the cap was 2.00 inches (about 50.8 mm) and the length or thickness of the cap was 0.531 inch (about 13.5 mm). The opening in the cap was sized to accommodate the horn; that is, the opening had a diameter of 0.75 inch (about 19.0 mm). The edge of the opening in the cap was a chamfer 156 which was the mirror image of the chamfer at the second end of the housing. The thickness of the cap at the chamfer was 0.125 inch (about 3.2 mm), which left a space between the end of the threads and the bottom of the chamfer of 0.094 inch (about 2.4 mm), which space was the same as the length of the collar on the horn. The diameter of such space was 1.104 inch (about 28.0 mm). The top 158 of the cap had drilled in it four 1/4-inch diameter×1/4-inch deep holes (not shown) at 90□ intervals to accommodate a pin spanner. Thus, the collar of the horn was compressed between the two chamfers upon tightening the cap, thereby sealing the chamber defined by the housing.

A Branson elongated aluminum waveguide having an input:output mechanical excitation ratio of 1:1.5 was coupled to the ultrasonic horn by means of a 3/8-inch (about 9.5-mm) stud. To the elongated waveguide was coupled a piezoelectric transducer, a Branson Model 502 Converter, which was powered by a Branson Model 1120 Power Supply operating at 20 kHz (Branson Sonic Power Company, Danbury, Conn.). Power consumption was monitored with a Branson Model A410A Wattmeter.

### Related Patents and Applications This application is one of a group of commonly assigned patents and patent applications. The group includes application Ser. No. 08/576,543 entitled “An Apparatus And Method For Emulsifying A Pressurized Multi-Component Liquid”, Docket No. 12535, in the name of L. K. Jameson et al.; application Ser. No. 08/576,536, now granted U.S. Pat. No. 6,053,424, entitled “An Apparatus And Method For Ultrasonically Producing A Spray Of Liquid”, Docket No. 12536, in the name of L. H. Gipson et al.; application Ser. No. 08/576,522 entitled “Ultrasonic Fuel Injection Method And Apparatus”, Docket No. 12537, in the name of L. H. Gipson et al.; application Ser. No. 08/576,174, now granted U.S. Pat. No. 5,803,106, entitled “An Ultrasonic Apparatus And Method For Increasing The Flow Rate Of A Liquid Through An Orifice”, Docket No. 12538, in the name of B. Cohen et al.; and application Ser. No. 08/576,175, now granted U.S. Pat. No. 5,868,153, entitled “Ultrasonic Flow Control Apparatus And Method”, Docket No. 12539, in the name of B. Cohen et al.; provisional application No. 60/254,737 entitled “Ultrasonic Fuel Injector with Ceramic Valve Body”, Docket No. 15781, in the name of Jameson et al.; provisional application No. 60/254,683 entitled “Unitized Injector Modified for Ultrasonically Stimulated Operation”, Docket No. 15872, in the name of Jameson et al.; provisional application No. 60/257,593 entitled “Ultrasonically Enhanced Continuous Flow Fuel Injection Apparatus and Method”, Docket No. 15810, in the name of Jameson et al.; and provisional application No. 60/258,194 entitled “Apparatus and Method to Selectively Microemulsify Water and Other Normally Immiscible Fluids into the Fuel of Continuous Combustors at the Point of Injection”, in the name of Jameson et. al. The subject matter of each of these applications is hereby incorporated by reference.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. An apparatus for improving the flow of a viscous liquid by the application of vibrational energy to the liquid, the apparatus comprising:
a housing;
a chamber contained within the housing comprising a first volume, the chamber adapted to receive a pressurized viscous liquid;
an inlet within the housing connected to the chamber adapted to supply the chamber with the pressurized viscous liquid;
a vestibular cavity having an entrance, the vestibular cavity contained within the housing and in direct communication via the entrance with the chamber, the vestibular cavity comprising a second volume, smaller than the first volume of the chamber, the entrance defining an area;
an exit orifice interconnected to the vestibular cavity, the exit orifice adapted to receive the pressurized viscous liquid from the vestibular cavity and pass the viscous liquid out of the housing; and
an ultrasonic horn having a nodal plane and a tip having a cross-sectional area, the horn being rigidly affixed to the housing such that the only portion of the horn to contact the housing is the nodal plane, the tip being disposed in substantially parallel spaced relation to the entrance of the vestibular cavity, wherein the cross-sectional area of the tip is substantially coaxially aligned with and is substantially the same area as the area of the entrance to the vestibular cavity.

2. The apparatus of claim 1, wherein the vestibular cavity is interconnected with the exit orifice via a passageway.

3. The apparatus of claim 1, wherein the ultrasonic horn is a magnetostrictive ultrasonic horn immersed in the liquid.

4. The apparatus of claim 1, wherein the exit orifice comprises a plurality of exit orifices.

5. The apparatus of claim 1, wherein the tip of the horn is about 0 inches to about 0.100 inches from the entrance to the vestibular cavity.

6. The apparatus of claim 1, wherein the exit orifice has a diameter of from about 0.0001 to about 0.1 inch.

7. The apparatus of claim 6, wherein the exit orifice has a diameter of from about 0.001 to about 0.01 inch.

8. The apparatus of claim 1, wherein the exit orifice is an exit capillary.

9. The apparatus of claim 8, wherein the exit capillary has a length to diameter ratio of from about 4:1 to about 10:1.

10. The apparatus of claim 1, wherein the ultrasonic energy has a frequency of from about 15 kHz to about 500 kHz.

11. The apparatus of claim 1, wherein the ultrasonic energy has a frequency of from about 15 kHz to about 100 kHz.

12. The apparatus of claim 1, adapted to pump liquids with viscosities between about 500 cP and about 5000 cP.

13. An apparatus for controlling the flow of a viscous liquid comprising:
a housing having;
a chamber adapted to receive a pressurized viscous liquid, the chamber having a first volume;
an inlet adapted to supply the chamber with the pressurized viscous liquid;
a vestibular cavity having an entrance in direct communication with the chamber, the vestibular cavity comprising a second volume, smaller than the first volume of the chamber, the entrance defining an area;
an exit adapted to receive the pressurized viscous liquid from the vestibular cavity and pass the viscous liquid out of the housing; and
an ultrasonic horn having a nodal plane and a tip; the tip having a cross-sectional area, the horn being rigidly affixed to the housing at the nodal plane, the tip being disposed in parallel spaced relation to the entrance of the vestibular cavity, wherein the cross-sectional area of the tip is coaxially aligned with and is the same area as the area of the entrance to the vestibular cavity.

14. An apparatus for controlling the flow of viscous liquids comprising:
a chamber adapted to receive and pass therethrough pressurized viscous liquids, the chamber defining a first volume;
a vestibular cavity connected to the chamber via an entrance, the entrance defining a cross-sectional area, the vestibular cavity comprising a second volume, smaller than the first volume of the chamber, adapted to receive and pass therethrough the pressurized viscous liquids from the chamber; and
an ultrasonic horn having a longitudinally vibrating tip; the tip having a cross-sectional area coaxially aligned with and comprising substantially the same area as the cross-sectional area of the entrance; wherein
the horn's vibrational energy is transferred to the pressurized viscous liquids contained within the vestibular cavity and not to the apparatus.
